(19) United States
(12) Patent Application Publication
(10) Pub. No.: US 2020/0280273 A1
(43) Pub. Date: Sep. 3, 2020

(54) STATIC SYNCHRONOUS MACHINE

(71) Applicant: Universidade Federal do Rio de Janeiro, Rio de Janeiro (BR)

(72) Inventor: André Ramos de CASTRO, Rio de Janeiro (BR)

(21) Appl. No.: 16/288,904

(22) Filed: Feb. 28, 2019

(51) Int. Cl. H02P 9/02

(52) U.S. Cl. CPC H02P 9/02

(57) ABSTRACT

A voltage source converter control concept which will be referred to as Static Synchronous Machine (SSM). The SSM provides an interface between AC and DC networks, extending to the DC link voltage the information implicitly transmitted through the system frequency. A generating unit connected to the DC link may implement the same, system-wide droop characteristic where 5% grid frequency (or DC link voltage) deviation from the rated value causes a 100% active power deviation. The efficacy of the method is verified by means of simulation and experimental results.

### FIELD OF THE INVENTION

The present invention relates to a voltage source converter control concept which will be referred to as Static Synchronous Machine (SSM).

### BACKGROUND OF THE INVENTION

Power electronics technologies have been of great importance in making renewable energy sources other than hydropower (alternative energy sources) viable for electric power generation. Most electric power generation solutions based on alternative energy sources require power electronics devices. Wind Turbine Generators, for example, may be connected directly to the grid. However, this implicates fixed speed operation, which limits the efficiency of the unit. As discussed by CHEN, Z., GUERRERO, J. M., BLAABJERG, F. “A Review of the State of the Art of Power Electronics for Wind Turbines”, IEEE Transactions on Power Electronics, v. 24, n. 8, pp. 1859-1875, August 2009. ISSN: 0885-8993. doi: 10.1109/TPEL.2009.2017082, the most efficient configurations use back-to-back converters connected either to its stator or to its rotor windings. Photovoltaic generation units and hydrogen fuel cells are DC sources and require inverters to connect to traditional AC grids and possibly also DC/DC converters to connect to a DC bus. Additionally, converters may be used to control the generating unit to keep it at the best possible operating point in terms of power extraction (Maximum Power Point Tracking, MPPT).

Distributed Generation is another trend that both feeds on and drives renewable energy source based generation growth. Distributed generation has been defined as an active power generation unit connected to the distribution network or on the customer side of the meter, as discussed by ACKERMANN, T., ANDERSSON, G., SODER, L. “Distributed generation: a definition”, Electric power systems research, v. 57, n. 3, pp. 195-204, 2001. In practice, it means a larger, better distributed set of generating units. Industrial facilities, commercial centers and residences become potential sites for a distributed generation plant. Distributed generation promises to lower dependence on new transmission lines, as it places generation units closer to consumers. Power supply reliability potentially increases as the number of components between generation and load decreases and the effects of loss of any single generating unit decreases. According to MILLER, N., SHAO, M., PAJIC, S., et al. Western Wind and Solar Integration Study Phase 3—Frequency Response and Transient Stability (Report and Executive Summary). Technical report, National Renewable Energy Laboratory (NREL), Golden, Colo., 2014, even if a number of distributed generation units of power equivalent to a traditional power plant is tripped, the effect on grid frequency is smaller than if the traditional power plant had been tripped. Distributed generation projects are typically smaller in size and complexity, presenting lower financial risks than traditional power plants. Additionally, distributed generation diversifies energy sources and increases competition in the energy market, as discussed by LOPES, J. P., HATZIARGYRIOU, N., MUTALE, J., et al. “Integrating distributed generation into electric power systems: A review of drivers, challenges and opportunities”, Electric power systems research, v. 77, n. 9, pp. 1189-1203, 2007.

It has been proposed that the inverters associated with distributed energy sources should be operated to mimic the behavior of a synchronous generator (SG). The term “static synchronous generator (SSG)” has been defined by the Institute of Electrical and Electronic Engineers (IEEE) to represent a static, self-commutated switching power converter supplied from an appropriate electric energy source and operated to produce a set of adjustable multi-phase output voltages, which may be coupled to an AC power system for the purpose of exchanging independently controllable real and reactive power. This was originally defined for one of the shunt-connected controllers in FACTS (flexible AC transmission system). This term is borrowed here to represent inverters which behave like synchronous generators. An SSG has the characteristics of an SG but without rotating parts (hence static). In this way, distributed energy sources can be made to operate on principles well understood in connection with conventional synchronous generators.

As is the case with synchronous machines, an SSM's basic synchronization mechanism consists of the fact that, given a DC link voltage higher than the grid frequency, in per-unit, an SSM's output voltage load angle will increase, leading to an increase of power output into the grid, consequently decreasing DC link voltage. Similarly, a low DC link voltage with respect to the grid frequency will decrease load angle (or increase a negative load angle's absolute value) and cause output power to decrease (or increase power consumption), lifting DC link voltage.

### SUMMARY OF THE INVENTION

The present invention seeks to provide a voltage source converter control concept which will be referred to as Static Synchronous Machine (SSM). An SSM imposes to a voltage source converter's output terminals balanced AC voltages whose angular speed equals, in a per-unit system, to its DC link voltage. This causes the active power control loop to be performed by the converter's own power circuit. A converter's energy is stored in its DC link capacitor, as an electrical machine's energy is stored in its rotor. The former, as electrostatic energy and the latter, as kinetic energy. Power electronics converters are devices that adapt electrical circuit interfaces, e.g.:
Connecting AC and DC circuits;
Connecting circuits (AC or DC) with different rated parameters (voltage, current, frequency, number of phases, etc.);
Increasing energy quality parameters (e.g. mitigating harmonics, voltage fluctuations);
Control power flow between circuits;
Provide services that increase electric power systems' stability and performance.

As such, the main design aspects that relate to a power electronics converter's capabilities are topology (the way circuit elements are combined) and control (the way measured quantities are used to influence the converter's behavior).

### BRIEF DESCRIPTIONS OF THE DRAWINGS

FIG. 1 shows a general scheme of the SSM control block.

FIG. 2 shows a comparison between traditional, synchronous generator based generating units, and an SSM based generating unit.

FIG. 3 is a diagram for considered power electronics based generating unit topology.

### DETAILED DESCRIPTION OF THE INVENTION

The present invention relates to a voltage source converter control concept which will be referred to as Static Synchronous Machine (SSM). The term static was used instead of virtual, as there are no virtual parameters in the sense used by other synchronous machine mimicking control topologies. The term synchronous machine was used instead of generator, as there is nothing in this control topology that implies it is supposed to function as a generator, i.e., its power flow is bidirectional.

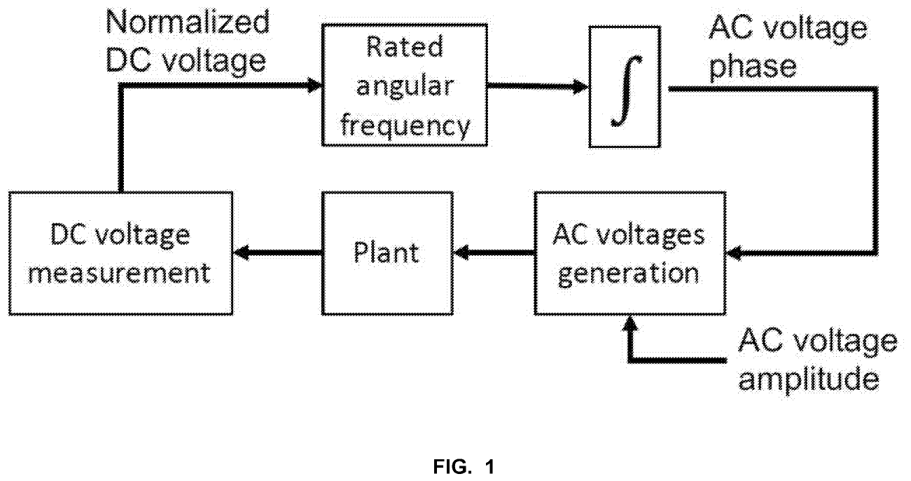

An exemplary SSM implementation is represented by the diagram in FIG. 1.

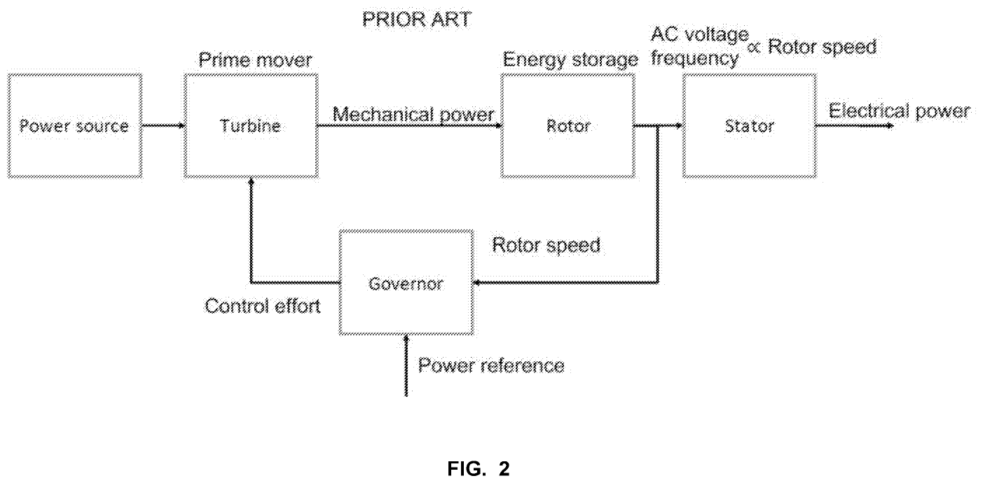

Similarly, to generating units based on synchronous machines, power sources connected to the DC link may implement droop controllers acting upon the DC link voltage. The SSM provides an interface between AC and DC networks which extends to the DC link voltage the information implicitly transmitted through the system frequency. A generating unit connected to the DC link may implement the same, system-wide droop characteristic where 5% grid frequency (or DC link voltage) deviation from the rated value causes a 100% active power deviation. With this configuration, power electronics based generation becomes more similar to traditional generation, with a correspondence between system elements as presented in FIG. 2.

Some advantages of this concept are as follows:
it does not need to calculate powers acting upon a virtual rotor (electromagnetic, damping, or governor). Its frequency is calculated by an analog Phase Locked Loop (PLL) system, the converter's DC link capacitor and AC power circuit;
it presents low computational burden;
it makes DC link energy part of the total system energy in a simple, unconvoluted way. This is interesting as it maintains the existing interpretation of inertia's role in power system stability;
for other synchronous machine mimicking control strategies, the DC link's dynamics are not clearly integrated into the synchronous machine equivalent model that they intend to be, although they may have a significant impact on it;
it allows for DC voltage droop mechanisms as multiple power sources feed a DC link, without communications, with each source's power output being proportional to DC voltage deviation (they don't need to measure AC grid frequency, because the same information is made available by the DC link voltage).

One embodiment of the invention is based on a controller given by a mathematical model of a synchronous generator and a three-phase, full-bridge, IGBT voltage source converter.

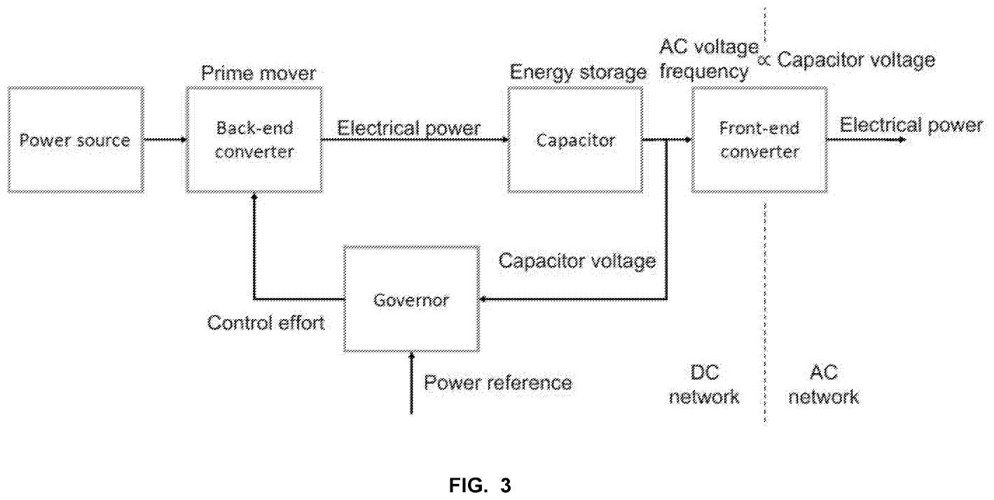

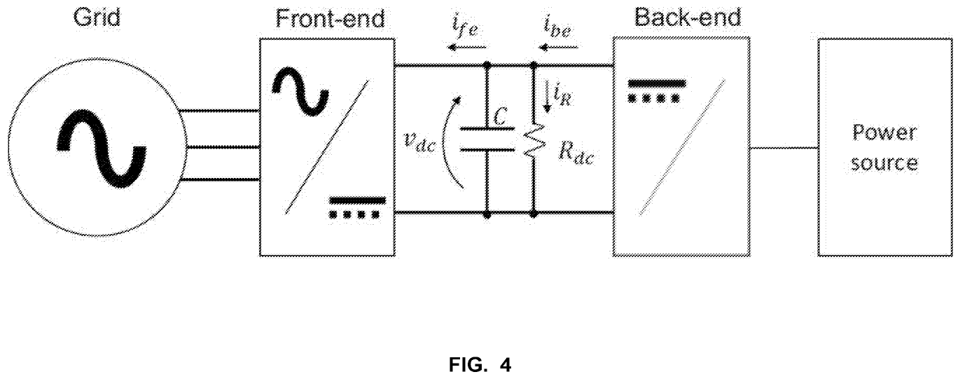

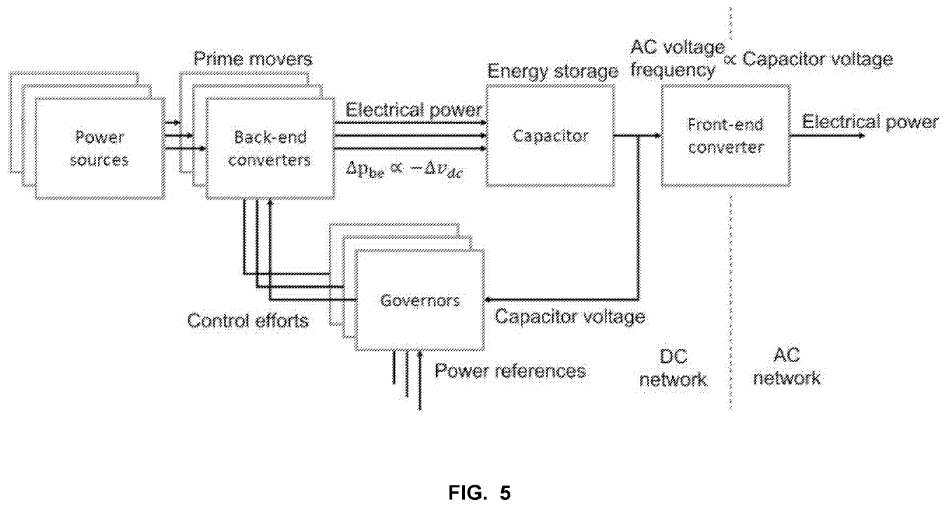

The DC link dynamics are described by a differential equation similar to a rotor's swing equation. Considering the circuit shown in FIG. 3, the DC link differential equation is as follows:

$$C \frac{d {v}_{d c} ( t )}{dt} = {i}_{b e} ( t ) - {i}_{f e} ( t ) - {i}_{R} ( t ) ,$$

### Where:

C is the DC link capacitor bank's total capacitance;
ν_{dc}(t) is the voltage across the DC link capacitor bank;
i_{be}(t) is the DC link current that comes from the back-end converter (connected to a power source);
i_{fe}(t) is the DC link current that goes into the front-end converter (connected to the grid);
i_{R}(t) is the DC link current that goes into the resistance connected in parallel with the capacitor bank.

A capacitor inertia constant may be defined as

$${H}_{C} = \frac{1}{2} \frac{C {v}_{d c b a s e}^{2}}{{P}_{b a s e}} .$$

A base current is also defined for DC link currents as

$${i}_{d c b a s e} = \frac{{P}_{b a s e}}{{v}_{d c b a s e}} .$$

Combining these equations gives

$$C = \frac{2 {H}_{C} {i}_{dcbase}}{{v}_{dcbase}} ,$$

which may be used to rewrite the capacitor differential equation as

$$2 {H}_{C} \frac{d {\overline{v}}_{d c} ( t )}{dt} = {\overline{i}}_{b e} ( t ) - {\overline{i}}_{{f}^{e}} ( t ) - {\overline{i}}_{R} ( t ) ,$$

where overbars mean per-unit values, values divided by their respective base values.

The DC link current from the back-end converter can be calculated from the power provided by the back-end converter and the DC link voltage through a non-linear relationship:

$${\overline{i}}_{b e} ( t ) = \frac{{\overline{p}}_{b e} ( t )}{{\overline{v}}_{d c} ( t )} .$$

It can be linearized around the operating point at t=0, as shown in the equation below.

$$Δ {\overline{i}}_{b e} ( t ) = - \frac{{\overline{p}}_{b e} ( 0 )}{{\overline{v}}_{d c}^{2} ( 0 )} Δ {\overline{v}}_{d c} ( t ) + \frac{1}{{\overline{v}}_{d c} ( 0 )} Δ {\overline{p}}_{b e} ( t )$$

The current drained by the parallel resistance in the DC link R_{dc} is given simply by

$${\overline{i}}_{R} ( t ) = \frac{{\overline{v}}_{d c} ( t )}{{\overline{R}}_{d c}} ∴ {\overline{i}}_{R} ( t ) = \frac{Δ {\overline{v}}_{d c} ( t )}{{\overline{R}}_{d c}} ,$$

where the base value for a DC link resistance is given by

$${R}_{d c b a s e} = \frac{{v}_{d c b a s e}^{2}}{{P}_{b a s e}} .$$

The active power p_{fe}(t) provided by the SSM, considering two three phase voltage sources with per-unit amplitudes ēₛₛₘ(t) and Ē_{TH}, a phase difference δ(t) and separated by a coupling impedance \vec{Z̅}=Z̅∠θ, is given by

$${\overline{p}}_{f e} ( t ) = \frac{{\overline{e}}_{ssm} ( t )}{\overline{Z}} [ {\overline{e}}_{ssm} ( t ) cos θ - {\overline{E}}_{TH} cos ( θ + δ ( t ) ) ] .$$

This expression neglects current transients and equals the steady state active power if we consider constant eₛₛₘ(t) and δ(t).

The DC link current going into the front-end converter can then be calculated as

$${\overline{i}}_{f e} ( t ) = \frac{{\overline{p}}_{f e} ( t )}{{\overline{v}}_{d c} ( t )} = \frac{{\overline{e}}_{ssm} ( t )}{{\overline{v}}_{d c} ( t ) \overline{Z}} [ {\overline{e}}_{s s m} ( t ) cos θ - {\overline{E}}_{TH} cos ( θ + δ ( t ) ) ]$$

The SSM's Root Mean Square (RMS), phase-to-phase internal voltage amplitude eₛₛₘ(t) is proportional to the voltage amplitude signal in FIG. 1, which shall be called ψ(t). In the analogy with a rotating synchronous machine, it can be regarded as the flux linkage due to the field winding. Its per-unit form is given by

$${\overline{ψ}}_{f} ( t ) = \frac{ψ ( t )}{{ψ}_{b a s e}} .$$

Considering the amplitude of the fundamental component in Sine Pulse-Width Modulation (SPWM), the SSM's internal voltage amplitude is then given by

$${e}_{ssm} ( t ) = \frac{\sqrt{3}}{2 \sqrt{2}} {v}_{d c} ( t ) ψ ( t ) ,$$

where ψ(t) may be regarded as an amplitude modulation ratio.

The per-unit voltage can be obtained dividing eₛₛₘ(t) by the base RMS phase-to-phase voltage V_{base}. Substituting the DC link voltage for the product between its per-unit value and its base value helps us define a base value for ψ(t), as

$${\overline{e}}_{ssm} ( t ) = \frac{{e}_{ssm} ( t )}{{V}_{b a s e}} = \frac{\sqrt{3}}{2 \sqrt{2}} \frac{{v}_{d c b a s e}}{{V}_{b a s e}} {\overline{v}}_{dc} ( t ) ψ ( t ) .$$

If we then choose the base value for ψ(t) as

$${ψ}_{b a s e} = \frac{2 \sqrt{2}}{\sqrt{3}} \frac{{V}_{b a s e}}{{v}_{d c b a s e}} = 2 \frac{{v}_{b a s e}}{{v}_{d c b a s e}} ,$$

where ν_{base} is the base peak phase voltage, then the SSM per-unit voltage amplitude can be expressed as the product between DC link voltage and the amplitude modulation ratio, as ēₛₛₘ(t)=ν̅_{dc}(t)ψ̅(t). In this analogy, DC link voltage corresponds to a rotating synchronous machine's rotor speed and the relationship where AC voltage amplitude is proportional to rotor speed and flux linkage holds for the SSM.

Front-end DC link current may then be rewritten as

$${\overline{i}}_{f e} ( t ) = \frac{1}{\overline{Z}} [ {\overline{v}}_{d c} ( t ) {\overline{ψ}}^{2} ( t ) cos θ - \overline{ψ} ( t ) {\overline{E}}_{TH} cos ( θ + δ ( t ) ) ]$$

and, after linearization, as

$$Δ {\overline{i}}_{f e} ( t ) = \frac{1}{\overline{Z}} \{ \overline{ψ} ( 0 ) {\overline{E}}_{TH} sin ( θ + δ ( 0 ) ) Δδ ( t ) + {\overline{ψ} ( 0 )}^{2} cos θ Δ {\overline{v}}_{d c} ( t ) + k Δ \overline{ ψ} ( t ) \} , \\ where \\ k = 2 \overline{ψ} ( 0 ) {\overline{v}}_{d c} ( 0 ) cos θ - {\overline{E}}_{TH} cos ( θ + δ ( 0 ) ) .$$

Developed equations can be used to write the first linearized differential equation:

$$\frac{d Δ {\overline{v}}_{d c} ( t )}{dt} = \frac{1}{2 {H}_{C}} [ Δ {\overline{i}}_{b e} ( t ) - Δ {\overline{i}}_{f e} ( t ) - Δ {\overline{i}}_{R} ( t ) ] .$$

The last SSM differential equation is the load angle's. The load angle grows with the difference between the voltages' frequencies ωₛₗᵢₚ(t)=ω_{base}ν̅_{dc}(t)−ω_{g}(t), where ω_{g}(t) is the variable frequency for the three phase voltage source to which the SSM is connected, according to the equation below:

δ(t)=δ(0)+∫₀^{t}ωₛₗᵢₚ(t′)=δ(0)+ω_{base}∫₀^{t}[ν̅_{dc}(t′)−ω̅_{g}(t′)]dt′

If it is assumed that DC link voltage and grid frequency are initially equal, in a per-unit system, then ωₛₗᵢₚ(0)=∴Δωₛₗᵢₚ(t)=ωₛₗᵢₚ(t) and ω_{base}Δν̅_{dc}(t)−Δω_{g}(t)=ω_{base}(ν̅_{dc}(t)−ν̅_{dc}(0))−ω_{g}(t)+ω_{g}(0)=ω_{base}ν̅_{dc}(t)−ω_{g}(t).

Therefore, the load angle's differential equation may be rewritten as

Δδ(t)=ω_{base}∫₀^{t}Δω̅ₛₗᵢₚ(t′)dt′=ω_{base}∫₀^{t}[Δν̅_{dc}(t′)−Δω̅_{g}(t′)]dt′,

The derivative of which gives the last differential equation:

$$\frac{d Δ δ t}{dt} = {ω}_{b a s e} [ Δ {\overline{v}}_{d c} ( t ) - Δ {\overline{ω}}_{g} ( t ) ] .$$

The initial conditions may be determined assuming initial power from the back-end converter p̅_{be}(o), initial amplitude modulation ratio ψ̅(0)=1 and initial grid frequency ω_{g}(0)=ω_{base} or ω̅_{g}(0)=1. The remaining variables' initial values are determined from the condition that the system is at an equilibrium at t=0:

$$\frac{d δ ( t )}{d t} {\vert}_{t = 0} = 0 ∴ {\overline{v}}_{d c} ( 0 ) = {\overline{ω}}_{g} ( 0 ) = 1 \\ \frac{d {\overline{v}}_{d c} ( t )}{d t} {\vert}_{t = 0} = 0 ∴ {\overline{i}}_{b e} ( 0 ) = {\overline{i}}_{f e} ( 0 ) + {\overline{i}}_{R} ( 0 )$$

The equilibrium condition for ν_{dc}(t) determines the initial current to the front-end converter as

$${i}_{f e} ( 0 ) = \frac{{\overline{p}}_{b e} ( 0 )}{{\overline{v}}_{d c} ( 0 )} - \frac{{\overline{v}}_{d c} ( 0 )}{{\overline{R}}_{d c}} = {\overline{p}}_{b e} ( 0 ) - \frac{1}{{\overline{R}}_{dc}} ,$$

which determines the initial load angle through the relationship

$$cos ( θ + δ ( 0 ) ) = \frac{1}{{\overline{E}}_{TH}} [ \overline{ψ} ( 0 ) {\overline{v}}_{d c} ( 0 ) cos θ - \overline{Z} \frac{{i}_{f e} ( 0 )}{ψ ( 0 )} ] = \frac{1}{{\overline{E}}_{TH}} [ cos θ - \overline{Z} ( {\overline{p}}_{b e} ( 0 ) - \frac{1}{{\overline{R}}_{dc}} ) ] .$$

This completes a linearized SSM state space model with state equation

\vec{\dot{x}}(t)=A\vec{x}(t)+B\vec{u}(t),

where state variables are given by

$$\vec{x} ( t ) = [ \begin{matrix}Δ δ ( t ) \\ Δ {\overline{v}}_{dc} ( t )\end{matrix} ]$$

and input variables are given by

$$\vec{u} ( t ) = [ \begin{matrix}Δ \overline{ψ} ( t ) \\ Δ {\overline{p}}_{b e} ( t ) \\ Δ {\overline{ω}}_{g} ( t )\end{matrix} ] .$$

A static synchronous machine was programmed into a back-to-back's front-end converter, with its back-end operating as a current-controlled, DC link regulating grid-tied converter. The DC link control implemented the same droop curve as is usually implemented for grid frequency control, a proportional gain of 20 (so a 5% DC link voltage deviation causes a 100% active power deviation), with no integral controller. It should be noted that the DC link control operated with an integral part before the front-end connection, so as to have its DC link voltage, and therefore its angular speed, be 1 p.u. at the moment of connection, when the integral control was immediately turned off (the input to the integral part of the controller was forced to be zero).

A Phase-Locked Loop (PLL) was used to provide the SSM with its DC link voltage integrator's initial output, the output voltage's phase at the moment of connection. The voltage amplitude at the moment of connection may be measured from the length of its vector, as calculated from the equipment's line voltage measurements, AB and BC, to provide the SSM with its initial voltage amplitude. When given a command to turn on, the SSM updates its initial amplitude, and phase, enables switching signals firing, and it may command contactors connecting its three-phase output terminal. This procedure minimizes connection transients.

In the diagram of FIG. 3 the power electronics based generating unit topology is demonstrated. The front-end converter is the one directly connected to the grid. The back-end converter is the interface to the primary power source (generator in a wind turbine or photovoltaic modules) and may be DC-AC or DC-DC.

### PROOF OF CONCEPT

The static synchronous machine was successfully connected to the grid, and it maintained continuous, stable operation in this condition for over three minutes. It was additionally connected to a resistive load and submitted to frequency swing tests (58.94 Hz average frequency nadir at an average rate of change of −0.765 Hz/s) when connected to AC voltages provided by another converter.

A new voltage source converter controller, and indeed a converter based generating unit control strategy, was proposed, tested experimentally and its contribution to frequency stability was measured. The SSM is a simple concept which establishes a closer relationship between synchronous machine based generation units and voltage source converter based generation units.

1. A control device for a voltage source converter, the control device implementing a model of a static synchronous machine comprising:
(1) an integrator whose input is a measured, per-unit, DC link voltage and whose output is multiplied by a rated AC angular frequency, to be used as an AC voltage reference phase, and
(2) variables representing a DC link voltage, an AC voltage phase, and an AC voltage amplitude;
wherein AC voltages applied to a voltage source converter's output terminal include balanced AC voltage references whose phases are calculated by said integrator.

2. The control device according to claim 1, in which power sources connected to a DC link are able to implement droop controllers acting upon the DC link voltage.

3. An apparatus for controlling a voltage source converter, the apparatus comprising a control device as claimed in claim 1 operatively connected to an interface between AC and DC networks, extending to the DC link voltage information transmitted through a system frequency.

4. An apparatus for controlling a voltage source converter, the apparatus comprising a control device as claimed in claim 2 operatively connected to an interface between AC and DC networks, extending to the DC link voltage information transmitted through a system frequency.
